(19) United States
(12) Patent Application Publication
(10) Pub. No.: US 2011/0251367 A1
(43) Pub. Date: Oct. 13, 2011

(54) BARRIER FOR GUIDED BONE REGENERATION

(76) Inventor: Munir Salomao, Sao Paulo (BR)

(21) Appl. No.: 13/130,249

(22) PCT Filed: Nov. 19, 2008
(86) PCT No.: PCT/BR2008/000352

§ 371 Date: Jun. 23, 2011

(51) Int. Cl. C08F 110/06

(52) U.S. Cl. 526/351

(57) ABSTRACT

Barrier for guided bone regeneration, patent of Utility Model, comprising a film of biaxially oriented polypropylene (BOPP), in sterile packing, for guided bone regeneration, with varied measures and formats.

The present patent of Utility Model has as objective a model of barrier biocompatible to be used in the guided regeneration of the bone tissue through specific surgical technique. Several biocompatible materials are surgically used as barriers in the guided bone regeneration.

The model presented here offers several advantages when compared with the existent models:

| Existent models | Presented model |
|---|---|
| They are removed at the end of | It can, or not, be removed soon after |
| the regeneration process. | the organization of the sanguine clot. |
| They cannot be exposed to the | It can, or not, be exposed to the |
| surface. | surface. |
| The cicatrization process needs | The cicatrization process happens |
| that the barrier is not exposed to | independently of the exposition of the |
| the ambiance. | barrier to the ambiance. |
| They are usually kept in position | It is kept by the own surgical incise |
| through screws or thumb tacks. | and by the suture. |
| — | It allows the regeneration of the soft |
| | tissue. |
| They need surgery for removal. | It doesn't need surgery for removal. |
| Difficult removal. | Easy removal. |

Considering the inconveniences verified in the use of the existent barriers and with the purpose of overcoming them, a barrier was developed using the film of biaxially oriented polypropylene (BOPP), object of the present patent, which doesn't present the problems and inconveniences found in the barriers commonly used for the same purpose.

Presented in several formats and in sterile packing, said barrier can still be cut out according to the need of each clinical situation. Basically, the format for each standard model presents the measures in centimeters described in the enclosed figures:

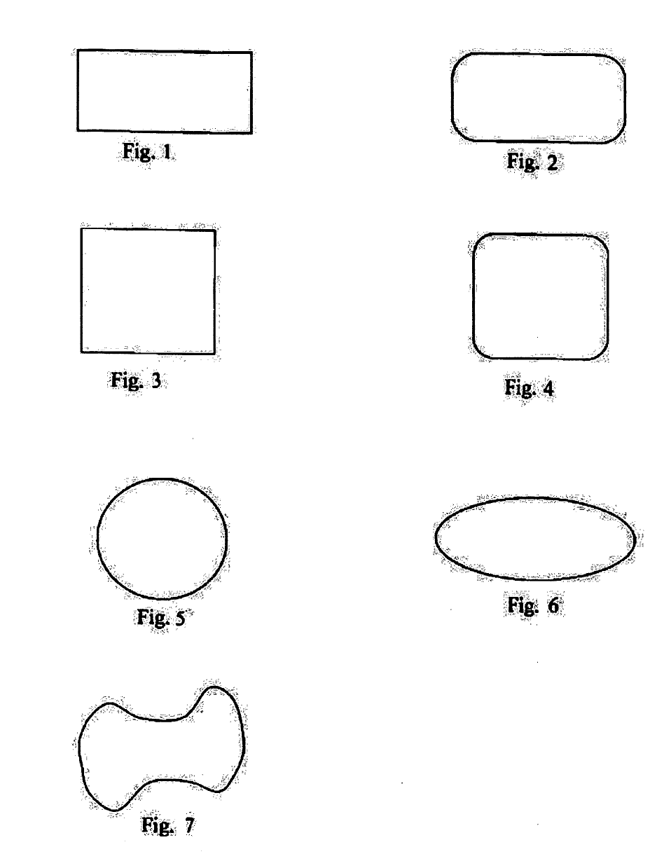

FIG. 1: Rectangular (2 cm×4 cm and 3.5 cm×4 cm);

FIG. 2: Rectangular with round corners (2 cm×4 cm and 3.5 cm×4 cm);

FIG. 3: Square (3,5 cm×3.5 cm);

FIG. 4: Square with round corners (3.5 cm×3.5 cm);

FIG. 5: Circulate (diameter 3 cm);

FIG. 6: Elliptic (3 cm×4 cm);

FIG. 7: In format of 8 (4 cm×2 cm).

1. “BARRIER FOR GUIDED BONE REGENERATION”, wherein uses film of biaxially oriented polypropylene (BOPP), in sterile packing, with measures in varied formats, with the purpose of obtaining bone regeneration.
